(19) United States
(12) Patent Application Publication
(10) Pub. No.: US 2011/0096624 A1
(43) Pub. Date: Apr. 28, 2011

(54) Sensing Technique for Seismic Exploration

(76) Inventor: Harini Varadarajan, Asker (NO)

(21) Appl. No.: 12/605,994

(22) Filed: Oct. 26, 2009

(51) Int. Cl. G01V 1/38; G01V 1/20

(52) U.S. Cl. 367/20; 367/177

(57) ABSTRACT

A technique facilitates performance of seismic surveys in a variety of land and marine environments. The technique employs one or more optical fibers designed for deployment in a seismic survey region. Each optical fiber comprises multiple seismic sensors that are formed in the optical fiber, and those multiple seismic sensors are utilized in detecting reflected seismic signals.

### BACKGROUND

Seismic surveys are performed in a variety of environments to gain a better understanding of subterranean geological formations. The seismic survey may be conducted by employing seismic sources to create pulses of energy which travel into the earth. The seismic signal is reflected from various subsurface features, and the reflected signal is detected by sensors deployed generally along the surface. For example, the sensors may be deployed along a land surface or in streamers deployed in the sea for a marine application. The sensors require a power supply which can limit the number of sensors or at least limit the distance over which the sensors are deployed.

### SUMMARY

In general, the present invention provides a technique designed to facilitate a seismic survey. The technique employs one or more optical fibers positioned in a seismic survey region. Each optical fiber comprises multiple seismic sensors that are formed in the optical fiber, and those multiple seismic sensors are utilized in detecting reflected seismic signals.

### BRIEF DESCRIPTION OF THE DRAWINGS

Certain embodiments of the invention will hereafter be described with reference to the accompanying drawings, wherein like reference numerals denote like elements, and:

FIG. 1 is a schematic view of a seismic sensor deployed in an optical fiber, according to an embodiment of the present invention;

FIG. 2 is a schematic illustration of a seismic sensor as illustrated in FIG. 1 but covered in an amplifying element, according to an embodiment of the present invention;

FIG. 3 is a schematic illustration of one embodiment of a seismic survey system employing a plurality of optical fibers each containing multiple seismic sensors, according to an embodiment of the present invention; and

FIG. 4 is schematic illustration of another embodiment of a seismic survey system employing a plurality of optical fibers each containing multiple seismic sensors, according to an alternate embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a technique for improving seismic surveys in a variety of environments. As described in greater detail below, the technique employs the use of one or more optical fibers with multiple seismic sensors incorporated into each optical fiber. The type and arrangement of sensors provide frequent, single sensor seismic measurements at closer vicinity with relatively low additional cost along a substantial span of the optical fiber. The optical fiber or fibers may be employed through a seismic survey region in a land environment, or they may be employed in streamer cables used in a marine survey region. The multiple sensors individually detect seismic displacements, while the system also enables compensation for temperature and strain from forces separate from the seismic displacement.

Each seismic sensor may be formed as a fiber Bragg grating sensor to create an inline array of sensors along each optical fiber. The use of multiple fiber Bragg grating sensors formed in the optical fiber provides an efficient approach to creating a substantial inline array of seismic sensors that do not require any power supply in marine and/or land applications. Consequently, virtually limitless seismic cable lengths are possible because there are no power budget issues to limit the number of seismic sensors employed in a given system.

In some embodiments, a plurality of optical fibers are provided in which each optical fiber has multiple seismic sensors, e.g. fiber Bragg grating sensors, located within the optical fiber. The optical fibers may be arranged in a generally parallel formation through a desired seismic survey region for cooperation with seismic sources which are used to impart seismic energy signals. Reflected seismic signals are detected by the multiple sensors to enable performance of the seismic survey throughout the desired region. The approach of placing a plurality of optical fibers in parallel may be employed in land and marine environments.

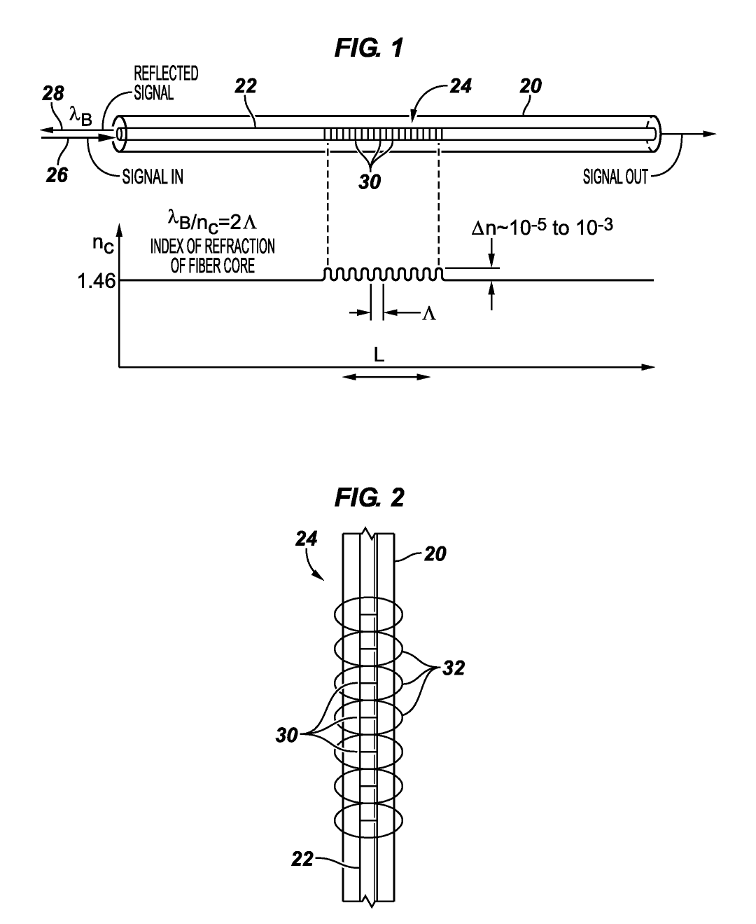

Referring generally to FIG. 1, one example of an optical fiber 20 is illustrated according to an embodiment of the present invention. In this example, the optical fiber 20 comprises an optical fiber core 22 which has a diameter smaller than the overall diameter of optical fiber 20. The ratio of diameters may vary from one application to another, but one suitable example for many applications uses an optical fiber 20 having a diameter of approximately 125 microns with a core diameter of approximately 8 microns. A seismic sensor 24 is illustrated as disposed within the optical fiber 20 and specifically within the core 22 of the optical fiber. A single seismic sensor 24 is illustrated for purposes of explanation, but the full length of optical fiber 20 comprises multiple seismic sensors 24 arranged as an inline array along the optical fiber 20.

Each seismic sensor 24 responds to a signal, as represented by arrow 26, delivered through optical fiber 20. By way of example, optical signals may be delivered through the optical fiber via a high speed tunable laser system. A reflected optical signal, as represented by arrow 28, is returned through the optical fiber 20 from seismic sensor 24 and may be used to determine characteristics of an external, seismic signal acting on each specific seismic sensor 24.

In the specific example illustrated, each seismic sensor 24 is a fiber Bragg grating sensor created by locating fiber Bragg gratings 30 at specific points along optical fiber core 22. By way of example, each fiber Bragg grating 30 may be photo written into the optical fiber core 22 by, for example, UV laser radiation. The periodic modulation and the refractive index of the fiber Bragg grating 30 and the optical fiber core 22 may be adjusted as desired for specific applications. In one specific example, however, the fiber Bragg grating is provided with about 0.01% of periodic modulation of the refractive index of the fiber core 22, having a diameter of approximately 8 microns, over a distance of a few millimeters. The period of index modulation versus the refractive index of the core is illustrated graphically beneath optical fiber 20 in FIG. 1.

In this example, the modulation provides a Bragg wavelength λ_{B} as follows:

λ_{B}=2n_{c}Λ,

where, n_{c} is the refractive index of the optical fiber core 22 and Λ is the period of index modulation. The Bragg center wavelength is unique to each fiber Bragg grating 30 and shifts linearly when there is a change in temperature or strain as represented by the following equation:

Δλ_{B}/λ_{B}=(1+ξ)ΔT+(1−ρₑ)ε,

where ξ is the thermal optics coefficient (dn/dt) and ε is the photo elastic coefficient.

Referring generally to FIG. 2, another example of a single seismic sensor 24 is illustrated. In this embodiment, each seismic sensor 24 is again formed as a fiber Bragg grating sensor by creating fiber Bragg grating 30 in optical fiber core 22 at desired locations along the optical fiber 20. In some applications, the seismic displacement of optical fiber 20 may be amplified by enclosing the seismic sensor 24 with a vibration amplifying material 32. By way of example, vibration amplifying material 32 may be wrapped around optical fiber 20 or coated onto optical fiber 20 to amplify the seismic signal/waves acting against each seismic sensor 24. Consequently, a more sensitive seismic sensor is created. The vibration amplifying material 32 may be formed from a variety of materials able to amplify the reflected acoustic energy. For example, the optical fiber 20 may be coated with silicone materials or polyamide materials.

The vibration amplifying material 32 effectively amplifies the seismic energy or waves that are reflected from the Earth's layers. This energy is converted to instantaneous longitudinal strain on optical fiber 20 and the fiber Bragg grating 30 in its optical fiber core 22. In essence, a “seismic meter” can be developed by recording the response of the seismic sensor 24 to known seismic waves. The sensing is accomplished at each unique seismic sensor 24 along the length of the optical fiber 20 which provides the potential for expansive sensing with multiple sensor points along the optical fiber.

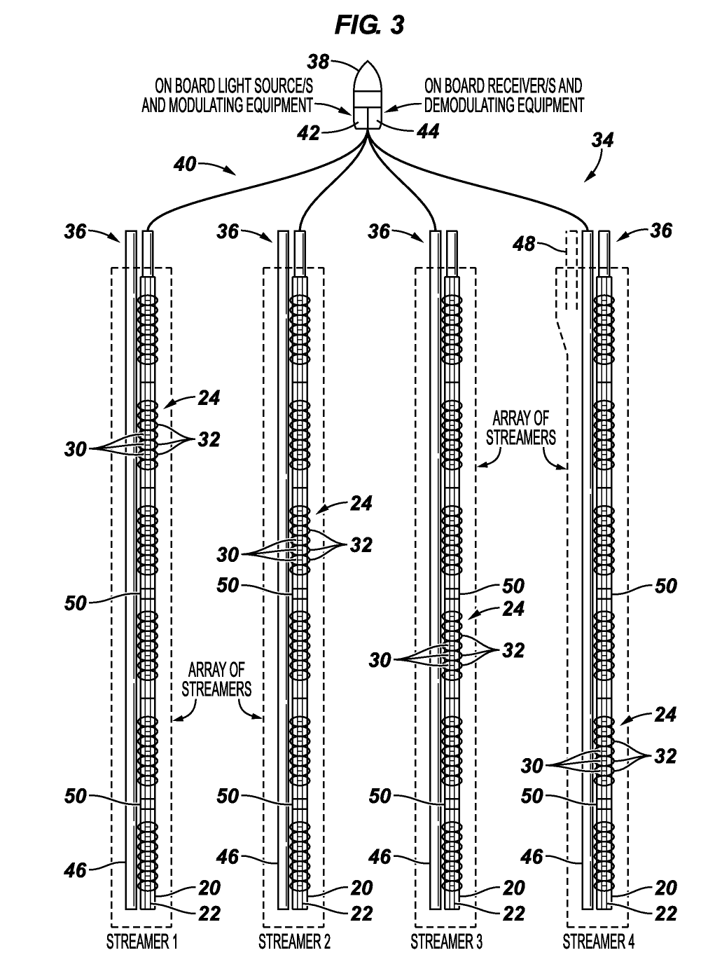

In FIG. 3, an example of an overall seismic survey system 34 is illustrated. In this particular example, the seismic survey system 34 is designed for use in a marine environment. As illustrated, system 34 comprises a plurality of optical fibers 20 with multiple fiber Bragg gratings 30 deposited within the fiber core 22 of each optical fiber. Accordingly, multiple seismic sensors 24 are formed along the length of the optical fiber 20.

When employed in marine applications, the plurality of optical fibers 20 may be positioned in a plurality of corresponding streamer cables 36. The streamer cables 36 are pulled through the sea by a tow vessel 38 which is connected to the plurality of streamer cables 36 via a suitable tow harness 40. During towing, the optical fibers 20 are aligned in a generally parallel configuration, and each optical fiber 20 comprises an inline array of multiple seismic sensors 24 formed by fiber Bragg gratings 30.

In the examples illustrated herein, the fiber Bragg gratings 30 are formed with unique center wavelengths so the response of each sensor grating 30 is independent of the response from the fiber Bragg gratings 30 of the other sensors 24. The optical fibers 20 and the seismic sensors 24 are used in cooperation with a high speed tunable laser system 42 which sends laser light signals through each optical fiber 20, as indicated by arrow 26 in FIG. 1. The response of each fiber Bragg grating 30 in each optical fiber 20 is unique and reflects an optical signal back to a high speed demodulation detection system 44. By way of example, the tunable laser system 42 and demodulation detection system 44 may be located on tow vessel 38. Using the high speed tunable laser system 42 in cooperation with the high speed demodulation detection system 44 enables measurement of the responses from a large array of seismic sensors 24 as with a conventional geophone.

When utilizing optical fibers 20, various external effects may be excluded by using one or more reference fibers 46. In the example illustrated, each optical fiber 20 is paired with a corresponding reference fiber 46, although other numbers and arrangements of reference fibers may be used in the overall seismic system 34. By way of example, the one or more reference fibers 46 may be used to exclude the temperature effect of the fiber Bragg gratings 30 in each optical fiber 20. Because the response of optical fiber 20 to temperature is a well-characterized effect, the effect may be removed from the resultant Bragg wavelength shift. For high-temperature applications, fibers coated with silicone PFA (up to 200° C.) and polyamide fibers (up to 300° C.) may be used. In other applications, standard acrylic fibers are useful up to approximately 85° C. However, a variety of other coating materials and/or fiber cable constructions may be employed as desired for specific seismic sensing applications.

Due to the linearity of the fiber Bragg gratings 30 for sensing nanostrain levels up to high temperatures, e.g. 500° C., the seismic sensors 24 are able to detect both small and large seismic waves. In some applications, the seismic wave amplifying material 32 may not be required in the event the strain levels produced are within the reaction specification of the fiber Bragg gratings 30 in the seismic sensors 24. By way of example, typical performance of fiber Bragg gratings 30, in terms of change in Bragg wavelength, is on the order of 1.2 pm/microstrain and 10 pm/degree Celsius. By amplifying the seismic displacements using a passive material surrounding each fiber Bragg grating 30 location, a three-dimensional seismic sensor is created which has sensitivity dependent on the vibration amplifying material 32.

In marine applications, such as the marine application illustrated in FIG. 3, one or more additional reference fibers 48 may be added to exclude other undesirable external effects. For example, the additional reference fiber or fibers 48 may be used to compensate for the effects of external mechanical forces acting against the streamer cables 36. Other components also may be added to the seismic system 34 to facilitate collection of seismic data in the marine environment. In one embodiment, for example, the seismic system 34 may be expanded to a more sensitive system by adding a plurality of electro-optic amplifiers 50. The electro-optic amplifiers 50 may be placed at fixed distances to record the received signals and to relay those signals back to the tow vessel 38. In at least some applications, the electro-optic amplifiers 50 are useful for improving signal quality.

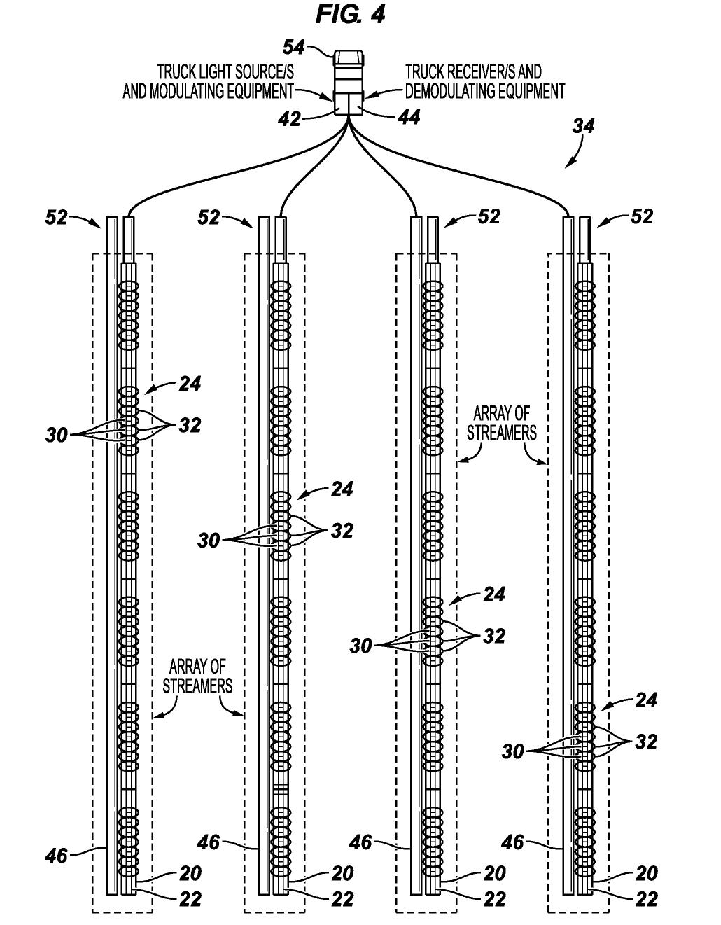

The seismic system 34 also may be employed in a variety of other types of applications, such as the land based application illustrated in FIG. 4. In this embodiment, a plurality of the optical fibers 20 are positioned in corresponding cables 52 which are deployed in a desired, land based, seismic survey region. As illustrated in FIG. 4, the cables 52 and corresponding optical fibers 20 may be arranged in a generally parallel configuration with multiple seismic sensors 24 along each optical fiber 20. In this example, the high speed tunable laser system 42 and the high speed demodulation detection system 44 may be mounted on a truck 54 or on another suitable land based vehicle or structure.

Regardless as to whether the seismic system 34 is a marine based or land based system, the performance of a comprehensive, efficient seismic survey is facilitated by the small size of the seismic sensors 24 that may be embedded within the optical fibers 20. The embedded seismic sensors 24 also provide extremely fast reaction times to enhance the collection of seismic data. Additionally, the use of optical fibers and the corresponding seismic sensors 24 enables multiple sensors to be used simultaneously for effectively providing a distributed sensing system. By way of example, channel widths may be comparable to that of conventional dense wavelength division multiplexing (DWDM) systems. By way of further example, the seismic system 34 may employ a suitable buffer, e.g. a 0.5 nm buffer, between channels to avoid crosstalk.

In both marine applications and land applications, the length of each marine streamer cable or land seismic cable may be lengthened by using more than one optical fiber in each streamer cable or seismic cable. In one example, the array of seismic sensors 24 on each optical fiber 20 is staggered with respect to the arrays of seismic sensors 24 on the other optical fibers of a given streamer cable or seismic cable. In this example, each group of optical fibers in a given streamer/seismic cable may be coupled to a separate demodulation system 44 used in cooperation with the overall detection equipment of seismic system 34.

Use of seismic sensors 24 with optical fibers 20 also provides a large degree of sensitivity which enables detection of low and high concentrations of seismic waves. In some applications, the vibration amplifying material 32 enhances the substantial sensitivity. The seismic system 34 also does not require any active components or electronics along a purely fiber sensor streamer because the data collection and analysis is performed at a centralized location. For example, streamers 36 (which are used in the marine application) relay data through the optical fibers 20 to the tow vessel 38 so that all data collection and analysis may be performed on board the tow vessel 38. Consequently, seismic system 34 can be a designed with an improved reliability because no connectors or junction points are required along the individual streamers.

The embodiments discussed above provide examples of systems, components and methodologies that may be used to enhance the collection and analysis of seismic survey data. Depending on the specific application and environment, the arrangement of systems and components may be changed or adjusted to accommodate the characteristics of the application and environment. For example, the length and number of optical fibers may be selected according to the size of the desired seismic survey region. Furthermore, the overall seismic system may be designed to accommodate a variety of environmental factors, including factors uniquely related to ocean environments and/or land environments.

The specific components of seismic system 34 also may be adjusted according to the specific seismic survey application. For example, the number and spacing of seismic sensors 24 along each optical fiber 20 may be adjusted. Additionally, the design and spacing of the fiber Bragg gratings may be adjusted to obtain the optimal detection characteristics for a given seismic application. Similarly, a variety of materials may be used as vibration amplifying material around each seismic sensor to provide a greater sensitivity for detection of seismic waves. Depending on the anticipated external effects, one or more reference fibers may be deployed at a variety of locations in the overall seismic system 34. Additionally, various components may be altered, added or supplemented to achieve the desired results for a given seismic survey application in a given environment.

Although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A method of facilitating a seismic survey, comprising:
forming an optical fiber with multiple seismic sensors located in the optical fiber;
positioning the optical fiber in a seismic survey region; and
utilizing the multiple seismic sensors to detect reflected seismic signals.

2. The method as recited in claim 1, wherein forming comprises forming the multiple seismic sensors as an inline array of seismic sensors that do not require a power supply.

3. The method as recited in claim 1, wherein forming comprises forming the multiple seismic sensors as multiple fiber Bragg grating sensors.

4. The method as recited in claim 3, wherein forming comprises depositing the multiple fiber Bragg grating sensors in a core of the fiber at positions throughout the length of the optical fiber.

5. The method as recited in claim 4, further comprising using a high speed tunable laser system in cooperation with a high speed demodulation detection system to measure individual responses from each fiber Bragg grating sensor along the optical fiber.

6. The method as recited in claim 4, further comprising utilizing a reference fiber positioned along the optical fiber to compensate for temperature effects.

7. The method as recited in claim 4, further comprising utilizing a reference fiber positioned along the optical fiber to compensate for external mechanical effects.

8. The method as recited in claim 1, wherein forming comprises forming a plurality of optical fibers arranged generally parallel to each other with each optical fiber comprising multiple seismic sensors.

9. The method as recited in claim 1, wherein positioning comprises positioning the optical fiber in a land environment.

10. The method as recited in claim 1, wherein positioning comprises positioning the optical fiber in a marine environment.

11. The method as recited in claim 3, further comprising enclosing each fiber Bragg grating sensor in a vibration amplifying material.

12. A system to facilitate a seismic survey, comprising:
a seismic survey system having a plurality of optical fibers, each optical fiber comprising multiple seismic sensors that are arranged in an inline array of seismic sensors formed in a core of each optical fiber.

13. The system as recited in claim 12, further comprising a plurality of reference fibers employed to compensate for at least one specific effect.

14. The system as recited in claim 12, wherein the multiple seismic sensors comprise multiple fiber Bragg grating sensors.

15. The system as recited in claim 14, wherein each fiber Bragg grating sensor is covered in a vibration amplifying material.

16. The system as recited in claim 14, further comprising a high speed tunable laser system working in cooperation with a high speed demodulation detection system to measure individual responses from each fiber Bragg grating sensor along the optical fiber.

17. A method, comprising:
placing multiple fiber Bragg grating sensors along each optical fiber of a plurality of optical fibers; and
utilizing the multiple fiber Bragg grating sensors as seismic sensors during a seismic survey operation.

18. The method as recited in claim 17, further comprising surrounding a plurality of the fiber Bragg grating sensors with a vibration amplifying material.

19. The method as recited in claim 17, further comprising arranging the plurality of optical fibers in generally parallel alignment through a seismic survey region.

20. The method as recited in claim 17, further comprising utilizing a reference fiber to compensate for temperature effects.

21. The method as recited in claim 17, further comprising utilizing a reference fiber to compensate for external mechanical effects.

22. The method as recited in claim 17, wherein utilizing comprises utilizing the multiple fiber Bragg grating sensors in a land based seismic survey.

23. The method as recited in claim 17, wherein utilizing comprises utilizing the multiple fiber Bragg grating sensors in streamers used in a marine based seismic survey.

24. The method as recited in claim 17, further comprising employing electro-optic amplifiers to expand data collection over a larger seismic survey region.
